(19) United States
(12) Patent Application Publication
(10) Pub. No.: US 2004/0224124 A1
(43) Pub. Date: Nov. 11, 2004

(54) Magnetic bath scale mat

(76) Inventors: Alejandro Herrera, Boca Raton, FL (US); Anson Wong, Boca Raton, FL (US)

Correspondence Address: Sunbeam Products, Inc., 2381Executive Center Drive, Boca Raton, FL, 33431, US

(21) Appl. No.: 10/431,127

(22) Filed: May 7, 2003

(51) Int. Cl. B32B 3/06

(52) U.S. Cl. 428/99; 428/131

(57) ABSTRACT

Disclosed is a mat for a bath scale, the mat having a flexible magnetic substrate adapted to magnetically attach to the standing surface of a bath scale and defining a meter opening for a meter window thereof. The mat may further comprise laminate polymer or textile layers bonded thereon, which may be colored or have graphics imprinted thereon.

### BACKGROUND OF THE INVENTION

1. Field of the Invention

This invention relates to mats that attach magnetically to weight scales.

2. Discussion of the Related Art

It is well known to provide weight scales, such as bathroom weight scales, with functional and decorative mats. Reibold, U.S. Pat. No. 3,243,2002, issued Mar. 29, 1966, for a BATH SCALE ASSEMBLY AND FRAME UNIT THEREFOR, discloses a carpeted mat affixed to the upper surface of a weight scale with a frame.

Providing a retaining frame adds an additional component to be assembled and adds to the cost of manufacturing the weight scale. Moreover, the frame must be disassembled from the weight scale in order to replace the mat. More typically, weight scale mats are therefore permanently affixed to the standing surface of a weight scale with an adhesive. With time and wear, however, the adhesive typically loses its strength and the mat begins to peel back at the corners. The exposed adhesive at the corners typically collect dirt and grime and the effect is unsightly. What is needed is a scale mat that is easily replaced and that does not peel away at the corners.

### BRIEF SUMMARY OF THE INVENTION

Disclosed is a bath scale mat, comprising a flexible magnetic substrate adapted to magnetically attach to the standing surface of a bath scale and defining a meter opening for a meter window thereof.

In another aspect of the invention, the meter opening is a slot.

In another aspect of the invention, the flexible magnetic substrate further comprises a polymer in which is dispersed a magnetic particulate.

In another aspect of the invention, the flexible magnetic substrate further comprises a coloring agent therein.

In another aspect of the invention, the particulate is anisotropic.

Another aspect of the invention further comprises at least one laminate layer bonded upon said magnetic substrate.

In another aspect of the invention, the magnetic substrate and said laminate layer comprise carbonaceous polymer.

In another aspect of the invention, the magnetic substrate and said laminate layer comprise silicon polymer.

In another aspect of the invention, the laminate is a textile.

In another aspect of the invention, the laminate is carpeting.

In another aspect of the invention, the magnetic substrate has graphics imprinted thereon.

In another aspect of the invention, the laminate layer has graphics imprinted thereon.

In another aspect of the invention, the laminate layer further comprises a coloring agent therein.

In another aspect of the invention, the textile has graphics imprinted thereon.

In another aspect of the invention, the textile has a coloring agent therein.

In another aspect of the invention, the textile has a pattern woven therein.

### BRIEF DESCRIPTION OF THE DRAWINGS

FIGS. 1a through 1c shows a top view of an embodiment of the invention and its use.

FIGS. 2a through 2c shows a top view of another embodiment of the invention and its use.

FIGS. 3a through 3c show cross-sections of alternative embodiments of the invention.

### DETAILED DESCRIPTION OF THE PREFERRED EMBODIMENTS

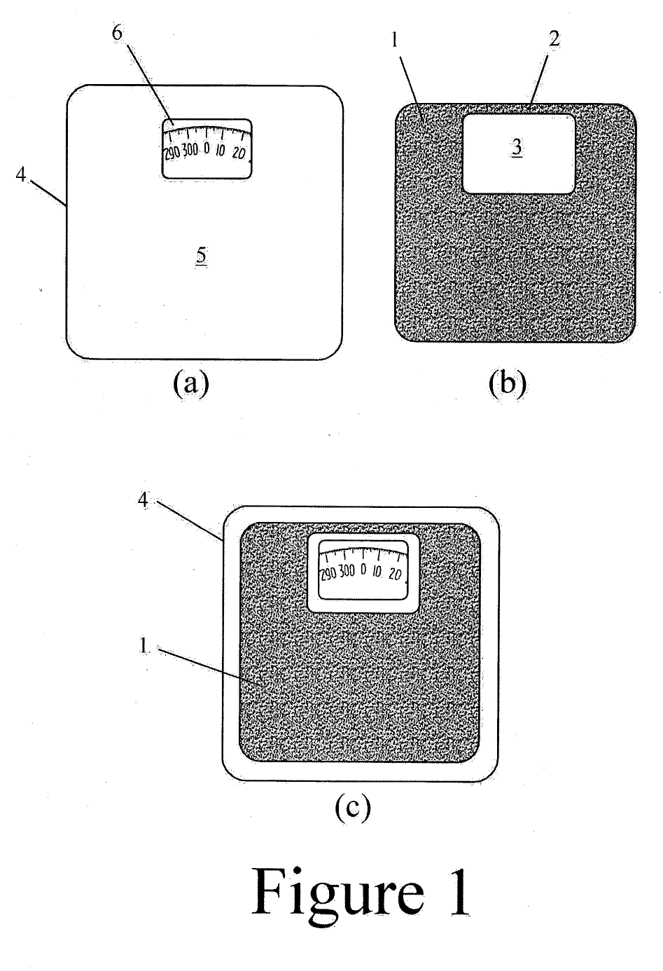

Referring to FIGS. 1a through 1c, there is shown a typical bath weight scale 4 having a standing surface 5 upon which a user stands to measure body weight. The user's weight is generally indicated through a meter window 6. A mat 1 of the invention defines a meter opening 3 such that when the mat 1 is placed upon the standing surface 5 of the scale 4, the meter window 6 is visible. In some applications, the meter window may be eliminated by locating the entire mat below the window.

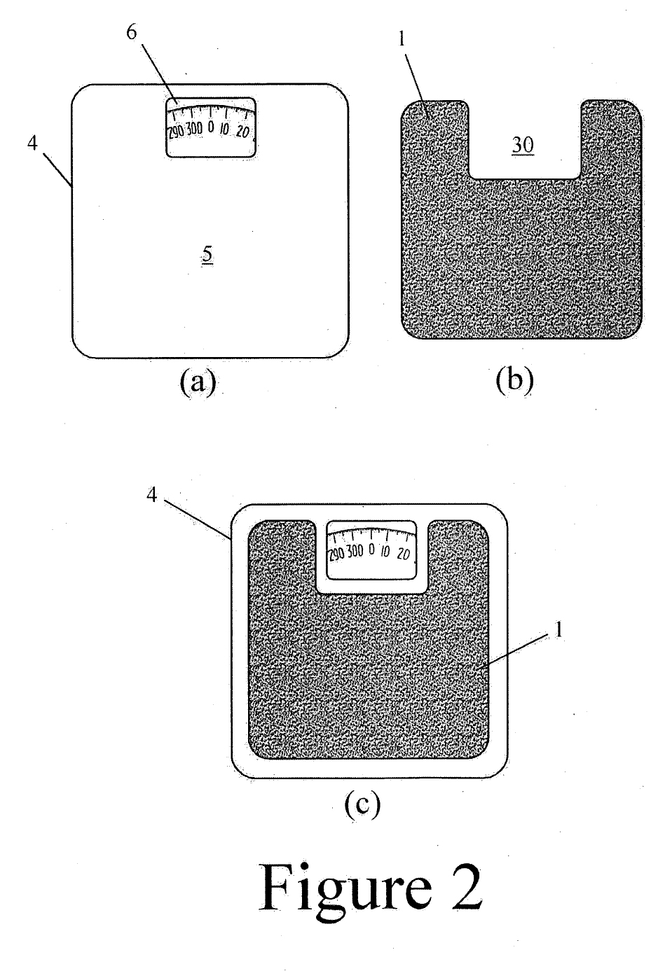

The upper boundary of the meter opening 3 is defined by a portion 2 of the mat. A benefit of this portion is in aiding the user in positioning the mat upon the scale. However, this portion 2 may often be very narrow in cases where the design of the scale 4 places the meter window 6 close to an edge of the standing surface 5. In such cases, the portion 2 may be so thin as to be relatively fragile and subject to tearing. FIGS. 2a through 2c show an embodiment that eliminates this problem.

Referring to FIGS. 2a through 2c, there is shown another embodiment of the invention wherein the opening 3 is a slot. This eliminates the problem of tearing a thin portion 2 (FIGS. 1b,c) of the mat completely.

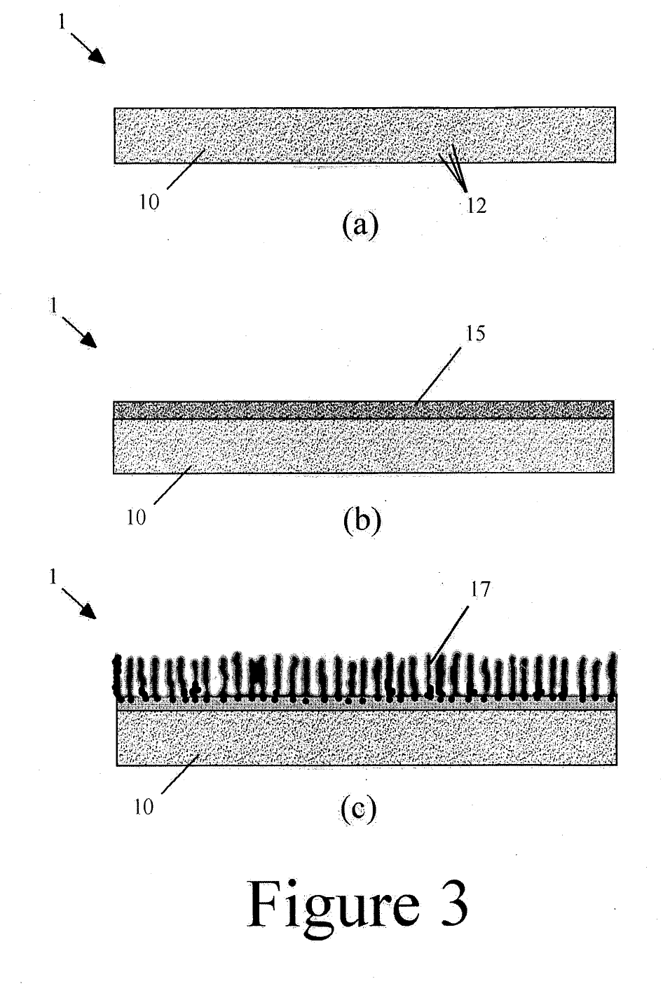

Referring to FIG. 3a, the mat 1 of the invention comprises a magnetic substrate 10, most preferably flexible. Such flexible magnetic substrates are well known in the art and widely commercially available. Typically, such magnetic substrates are formed of a polymer substrate, such as a carbonaceous or silicon rubber, interspersed with magnetic particulate 12. The particulate is generally a ferrite, such as for example a strontium ferrite or barium ferrite, or any number of magnetizable compounds, such as neodymium-iron-boron, samarium cobalt, and aluminum-nickel-cobalt powders and the like. The orientation of the particulate may be randomly distributed (e.g., isotropic) throughout the substrate and therefore magnetized in any direction, or may be aligned in the same direction (anisotropic) and then preferably magnetized in the direction of alignment. Anisotropic magnetic particulate provides a stronger magnetic field to the flexible magnet substrate. Preferably, the magnetic substrate will have a rubbery texture so as to prevent slipping when wet. The polymeric nature of the material also acts as a thermal insulator to shield the user's feet from the cold metal upper surface 5 of the bath scale.

As can be seen, because the mat 1 of the invention attaches to the weight scale 4 magnetically, it is easily replaced when worn and the corners never separate from the upper surface 5 of the scale and curl up.

FIG. 3b shows another embodiment of the mat 1 of the invention wherein one or more upper laminate layers 15 are bonded to the magnetic substrate 10. By providing a laminate, it is possible to present a desired texture or appearance to the user that the magnetic substrate alone would otherwise lack. Such an upper laminate layer may comprise a polymeric material that tightly bonds to the magnetic substrate 10, such as vinyls like, for example, polyvinyl chloride, polypropylenes, polycarbonates, rubbers, laminated papers, or any other carbonaceous polymer, silicon-based polymer, or other material suited to the purpose. Bonding agents include a wide variety of adhesives known in the art, such as acrylic adhesives. The bonding together of like materials, such as a carbonaceous upper layer to a carbonaceous magnetic substrate, or a silicon-based upper layer to a silicon-based magnetic substrate, produces a far stronger bond than that between a polymer and a metal surface. Hence, these laminates as shown in FIG. 3b rarely suffer from peeling and curling of corners, even with rigorous use.

Graphics may be printed on the mat of the invention, either directly upon the magnetic substrate 10 or upon a laminate layer 15 that is chosen for the purpose.

Alternatively, the magnetic substrate or laminate layer(s) may have dyes or other suitable coloring agents therein to give color to the mat.

Referring to FIG. 3c, there is shown yet another embodiment of the invention wherein the “laminate” is a textile layer 17, such as cloth, canvass, carpeting, rug pile or the like. In this case, the graphics may be woven into the textile layer. Alternatively, the textile may be dyed in a coloring agent or have graphics imprinted thereon.

While various values, scalar and otherwise, may be disclosed herein, it is to be understood that these are not exact values, but rather to be interpreted as “about” such values, Further, the use of a modifier such as “about” or “approximately” in this specification with respect to any value is not to imply that the absence of such a modifier with respect to another value indicated the latter to be exact.

Changes and modifications can be made by those skilled in the art to the embodiments as disclosed herein and such examples, illustrations, and theories are for explanatory purposes and are not intended to limit the scope of the claims. Further, the abstract of this disclosure is provided for the sole purpose of complying with the rules requiring an abstract so as to allow a searcher or other reader to quickly ascertain the subject matter of the disclosures contained herein and is submitted with the express understanding that it will not be used to interpret or to limit the scope or the meaning of the claims.

What is claimed is:

1. A bath scale mat, comprising:
a flexible magnetic substrate adapted to magnetically attach to the standing surface of a bath scale and defining a meter opening for a meter window thereof.

2. The apparatus of claim 1 wherein said meter opening is a slot.

3. The apparatus of claim 1 wherein said flexible magnetic substrate further comprises a polymer in which is dispersed a magnetic particulate.

4. The apparatus of claim 1 wherein said flexible magnetic substrate further comprises a coloring agent therein.

5. The apparatus of claim 3 wherein said particulate is anisotropic.

6. The apparatus of claim 1 further comprising at least one laminate layer bonded upon said magnetic substrate.

7. The apparatus of claim 6 wherein said magnetic substrate and said laminate layer comprise carbonaceous polymer.

8. The apparatus of claim 6 wherein said magnetic substrate and said laminate layer comprise silicon polymer.

9. The apparatus of claim 6 wherein said laminate is a textile.

10. The apparatus of claim 9 wherein said laminate is carpeting.

11. The apparatus of claim 1 wherein said magnetic substrate has graphics imprinted thereon.

12. The apparatus of claim 6 wherein said laminate layer has graphics imprinted thereon.

13. The apparatus of claim 6 wherein said laminate layer further comprises a coloring agent therein.

14. The apparatus of claim 9 wherein said textile has graphics imprinted thereon.

15. The apparatus of claim 9 wherein said textile has a coloring agent therein.

16. The apparatus of claim 9 wherein said textile has a pattern woven therein.

17. A bath scale mat, comprising:
a substrate adapted to fit upon a standing surface of a bath scale; and
magnetic means for attaching said substrate to said bath scale;

18. The mat of claim 17, further comprising means for permitting viewing of a meter window of said bath scale;

19. The mat of claim 17, further comprising laminate means for providing a desired upper surface for said substrate.
